(19) United States
(12) Patent Application Publication
(10) Pub. No.: US 2009/0091278 A1
(43) Pub. Date: Apr. 9, 2009

(54) Downhole Load Sharing Motor Assembly

(76) Inventors: Michael Montois, Houston, TX (US); Todor K. Sheiretov, Houston, TX (US)

Correspondence Address: SCHLUMBERGER IPC;ATTN: David Cate, 555 INDUSTRIAL BOULEVARD, MD-21, SUGAR LAND, TX, 77478, US

(21) Appl. No.: 12/246,785

(22) Filed: Oct. 7, 2008

Related U.S. Application Data
(63) Continuation-in-part of application No. 11/854,370, filed on Sep. 12, 2007.
(60) Provisional application No. 60/998,687, filed on Oct. 12, 2007.

(51) Int. Cl. H02P 6/04

(52) U.S. Cl. 318/400.15

(57) ABSTRACT

A motor assembly of multiple motors for use in driving a shared downhole load within a well. In particular, the assembly may employ substantially constant adjustable speed motors. These may include permanent magnet synchronous machine motors. The motors may be configured to operate at given speeds that may be downwardly adjusted depending on the amount of torque output independently exhibited by the individual motors. In this manner, a significant divergence in torque output between the motors may be avoided so as to ensure substantial load sharing between all of the motors of the assembly.

### CROSS REFERENCE TO RELATED APPLICATION(S)

This Patent Document is a continuation-in-part claiming priority under 35 U.S.C. §120 to U.S. application Ser. No. 11/854,370 entitled Electronic Motor, filed on Sep. 12, 2007, and incorporated herein by reference in its entirety. In addition, this Patent Document claims priority under 35 U.S.C. §119(e) to U.S. Provisional Application Ser. No. 60/998,687, entitled, Load Sharing Between Two Electric Motors, filed on Oct. 12, 2007, and incorporated herein by reference in its entirety.

### BACKGROUND

Embodiments described relate to motors for driving a load downhole within a well. In particular, embodiments of load sharing motors in the form of a downhole power assembly are described. The motor assembly may be configured to dimensionally fit the downhole environment and to drive a load with enhanced sharing between the motors themselves.

### BACKGROUND OF THE RELATED ART

Drilling, completing, and operating hydrocarbon wells involves the employment of a variety of powered equipment. For example, large scale surface equipment is generally employed at the oilfield in the form of positive displacement pumps, mixers, and material delivery units to name a few. Additionally, a host of smaller downhole equipment, such as tractors and logging equipment are often employed within the well itself. As detailed below, a piece of surface equipment, such as a single positive displacement pump, may be powered by multiple motors which share the load of driving the operation of the pump. Indeed, even outside of the oilfield industry, multiple motors are often employed to share a common load. In this manner, separate motors may be stacked and combined in a user friendly manner to form a motor assembly for any given piece of equipment. Thus, the need to build a larger unitary single use motor for each piece of equipment may be obviated.

With separate motors, however, there is an inherent tendency for one motor to take on an increasing amount of load while the other starts to contribute less and less. Thus, when employing multiple motors to share a common load, the motors may be controlled in a synchronized manner. Synchronization may be employed to ensure that one of the motors is not employed to a substantially greater degree than the other. Rather, each motor may be directed to share a balance of about 50% of the load may be sought so as to avoid undue wear or premature failure of one of the motors. Additionally, avoiding under-utilization of the other motor in this manner may also enhance efficiency of the overall motor assembly operation.

Synchronization of multiple motors sharing a common load is often achieved by way of what is referred to as a ‘master-slave’ assembly configuration. In this type of a set-up, a ‘master’ motor is communicatively paired with a ‘slave’ motor. The master motor is operated at an initial given torque output that is set above an initial torque output of the slave motor. Nevertheless, the unbalanced nature of this pairing is substantially eliminated as the motors begin to operate and communicate with one another. That is, as the motors begin to power the equipment, the torque output of the master motor is communicated to the slave motor. The slave motor responds by raising its torque output and allowing the torque output of the master motor to be reduced until a substantial equilibrium of torque output is achieved between the motors.

Unfortunately, as the load on the master-slave motor assembly increases, the response of the assembly is to initially elevate the torque output provided by the master motor until communication between the motors results in re-establishing the equilibrium as noted above. Thus, when the motor assembly is initially turned on and upon any increase in load thereafter, there is an imbalance of load until equilibrium can be re-established. As noted above, during this period of unbalanced load, the assembly still operates in a fairly inefficient manner and with disproportionate wear on the master motor. Furthermore, the master motor, like any, may be unable to operate without stalling, overheating or other malfunctioning when directed to pull a load beyond its own inherent limitations. Nevertheless, in a master-slave motor configuration as described, the likelihood that the master motor will be directed to exceed an operational load threshold is increased during the allowed periods of unbalanced load. Should the master motor fail due to such an exceeded threshold, the entire assembly will cease to function.

In light of the master slave drawbacks noted above, attempts may be made to minimize the period of unbalanced load. That is, the delay in achieving the equilibrium may be kept to a minimum by maximizing the rate of communication and response between the motors. This may be achieved by programming the motor controls to communicate and effectuate motor responses at extremely high rates. Unfortunately, this places a high performance criteria on the electronics of the assembly. As such, an expensive, intricate and large bus communication may be utilized that is, nevertheless, susceptible to being overloaded during operation of the master-slave motor assembly.

In addition to the problems noted above, a conventional mechanical motor, as may be employed in a master slave assembly, provides an efficiency that is generally well below about 70%. Thus, even where efficiency is improved through a complex bus communications and relays, inherent efficiency limitations remain. Furthermore, the employment of multiple motors to share a common load in the oilfield industry presents a particular challenge to downhole equipment such as the above noted tractor. That is, unlike a surface pump, downhole equipment is configured for deployment within a well where space is at a premium. For example, a standard well may be no more than about a foot in diameter, if that. This makes use of conventional mechanical motors generally impractical.

### SUMMARY

A motor assembly is provided for use downhole in a well. The assembly includes a first substantially constant adjustable speed motor and a second substantially constant adjustable speed motor. The motors are coupled to one another and configured for deployment in the well. The motors are also configured to each accommodate a substantially equivalent share of a load in the well.

A downhole assembly is provided for operating in a well. The assembly includes a load providing device coupled to first and second motors. The first motor is configured to operate at a first speed and the second motor configured for operating at a second speed. The speed of each motor is to be reduced based on a corresponding torque output of each motor.

### BRIEF DESCRIPTION OF THE DRAWINGS

FIG. 1 is a diagram of an embodiment of a downhole load sharing motor assembly for moving a load.

FIG. 2 is a side view of the load sharing motor assembly of FIG. 1 depicted downhole within a well for pulling the load of a downhole tractor and diagnostic tool.

FIG. 3 is a perspective overview of an oilfield with the load sharing motor assembly, tractor and tool of FIG. 2 disposed within the well.

FIG. 4A is a chart depicting an embodiment of employing the load sharing motor assembly in absence of a speed adjustment technique.

FIG. 4B is a chart depicting an embodiment of a speed adjustment technique for use with the load sharing motor assembly of FIG. 4A.

FIG. 4C is a chart depicting an embodiment of employing the load sharing motor assembly of FIG. 4A with the speed adjustment technique of FIG. 4B.

FIG. 5 is a flow-chart summarizing an embodiment of employing a downhole load sharing motor assembly.

### DETAILED DESCRIPTION

Embodiments are described with reference to certain downhole multiple motor assemblies which are configured to share a load. In particular, assemblies employing two permanent magnet synchronous machine (PMSM) motors are described. However, other types of motor assemblies may be employed with differing numbers of motors. For example, more than two motors may be employed with the assembly. Regardless, embodiments described herein may include assemblies with downhole PMSM motors, or other substantially constant adjustable speed motors configured to display substantial equilibrium in torque output during a downhole operation. Additionally, as used herein, the term “substantially constant adjustable speed motor” is meant to refer to a motor configured to operate at a substantially constant speed during operation such as a conventional PMSM, but which may also be actively directed to adjust its speed during operation.

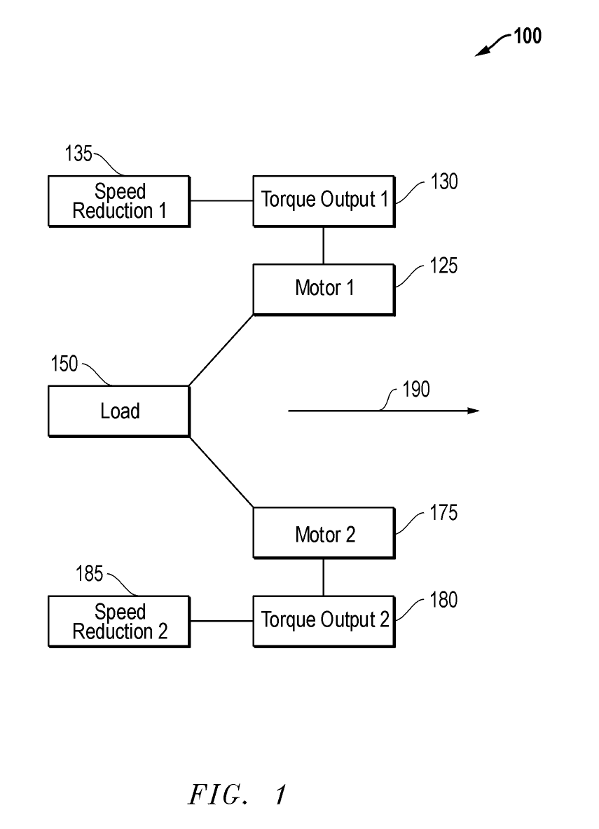

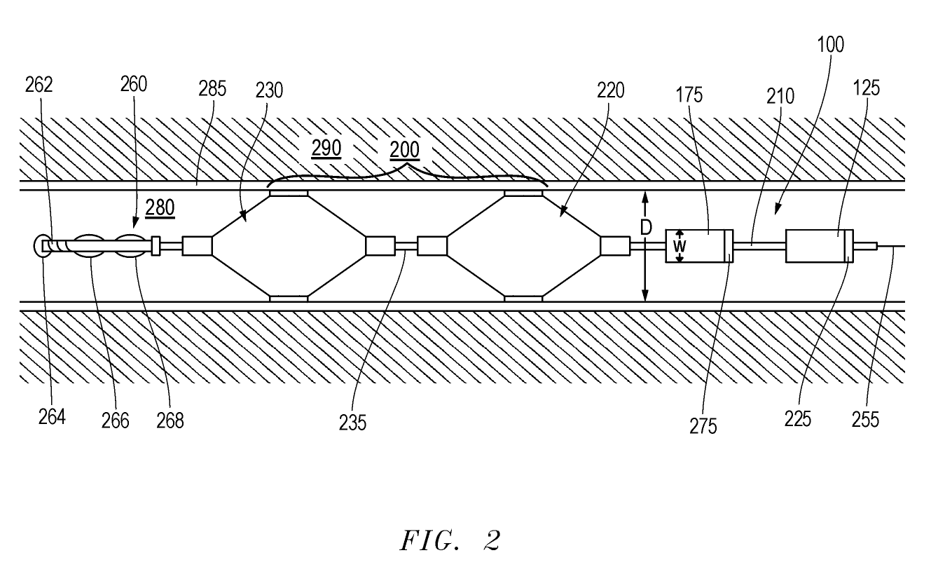

Referring now to FIG. 1, a diagram of a downhole load sharing motor assembly 100 is depicted for driving a load 150. More particularly, the assembly 100 is depicted as pulling a load 150 from left to right as indicated by arrow 190. Indeed, FIG. 2 reveals a more real-to-life representation of the assembly 100 pulling the load of downhole equipment including a tractor 200 and a diagnostic tool 260 (from left to right as depicted in the well 280). As the diagram of FIG. 1 reveals, pulling of the load 150 is shared by motors 125, 175 of the assembly 100 (i.e. “Motor 1” and “Motor 2”). The total power necessary to pull the load 150 in the direction of the arrow 190 is supplied by the cumulative torque outputs 130, 180 of each motor 125, 175 (i.e. “Torque Output 1” and “Torque Output 2”). That is, as depicted in the diagram of FIG. 1, the motors 125, 175 share in pulling the load 150.

In one embodiment, the motors 125, 175 are each configured to run at substantially the same constant speed, whereas the torque output 130, 180 may be variable dependent upon the amount of load 150 imparted on the respective motor 125, 175. For example, the motors 125, 175 may be of a permanent magnet synchronous machine (PMSM) variety, generally configured to run at a substantially constant speed with variable torque output. However, as also depicted in FIG. 1, the given speed of each motor 125, 175 may be downwardly adjusted depending upon the amount of torque output 130, 180 exhibited by each of the respective motors 125, 175. That is, while the motors 125, 175 are mechanically lined and outwardly display substantially the same speed, speed reduction 135, 185 may be selectively applied to each motor 125, 175 as the load 150 is pulled so as to also ensure substantially equivalent torque outputs 130, 180.

The principle of the above-noted technique is that by lowering the speed of Motor 1 125 for example, in conjunction with any increase in its torque output 130, an increase in the torque output 180 of Motor 2 175 will be prevented. Thus, as a practical matter, neither motor 125 or 175 will be able to provide a substantially greater torque output 130, 180 than the other. This speed reduction technique may be represented by the equation below:

ωm=ωref−kτ

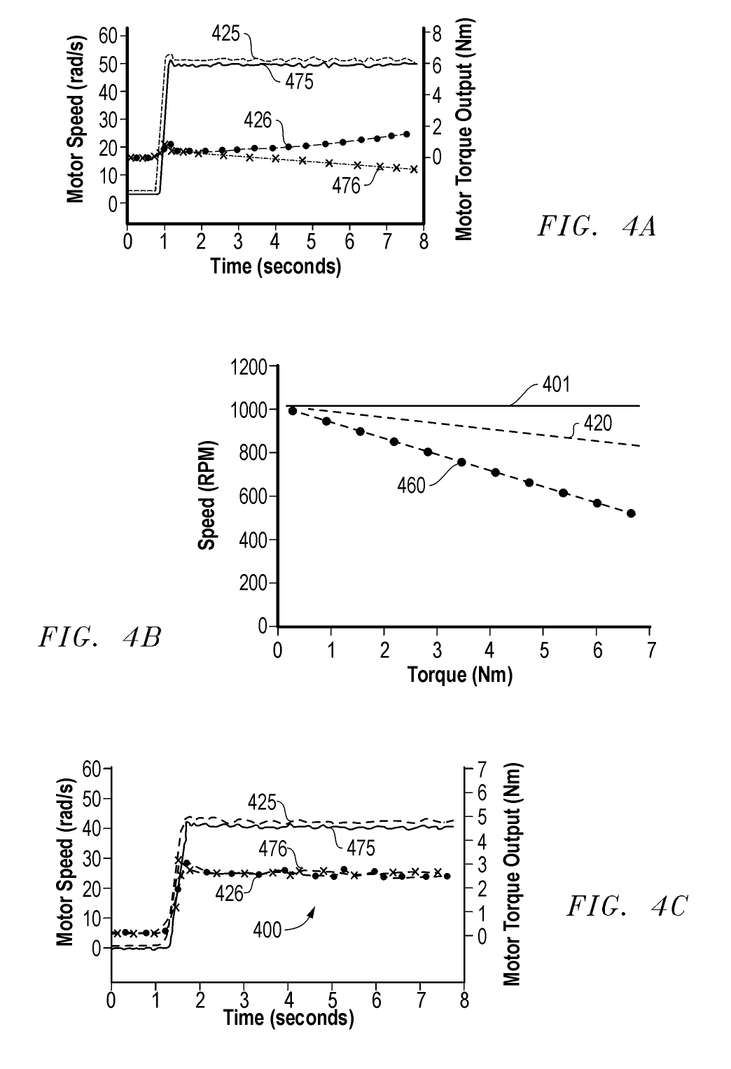

In this equation, ωm is the actual speed of a motor such as Motor 1 125 which, as indicated by the equation, is determined by a predetermined given speed (ωref) that is reduced by kτ, where τ is the torque output 130 and k is a predetermined constant. The application of this speed reduction technique and its effects are graphically displayed with reference to FIGS. 4A-4C which are described in greater detail below. With added preliminary reference to these Figs., however, a speed reduction 135, 185 of 20 RPM for each Newton meter (Nm) of torque output 130, 180 may be graphically represented by the broken line 420 of FIG. 4B. When applied, this may result in maintaining substantially equivalent torque outputs 130, 180 as graphically represented in FIG. 4C. In this manner, substantially equivalent sharing of the load 150 is undertaken by each of the motors 125, 175. That is, by way of separately applied negative feedback, an inherent load share between the motors 125, 175 is induced.

As indicated above, a substantial equilibrium of load sharing is achieved between the motors 125, 175 as a result of speed reduction 135, 185. This substantial balance between the motors 125, 175 may help to avoid undue wear on one motor 125, 175 over another. Additionally, this also helps to enhance the overall efficiency of the assembly 100 by avoiding under-utilization of either motor 125, 175. Furthermore, the substantial equilibrium of torque output 130, 180 between the motors 125, 175 is ultimately maintained by adjusting motor speed as opposed to relying on communication between the motors 125, 175.

Unlike a master-slave configuration, the embodiments described herein achieve balance without the requirement of a sophisticated bus or high-speed microprocessor communication between the motors 125, 175. Indeed, balance may be achieved without any direct communication of torque output information from one motor 125, 175 to the other. Thus, communication delays are entirely obviated as is the need to intentionally allow one motor 125, 175 to initially provide a torque output 130, 180 significantly greater than the other, as is often the case with a master-slave configuration. This eliminates an intentional period of imbalance and lessens the likelihood that one of the motors 125, 175 will exceed its torque output threshold and stall out or otherwise fail, thereby shutting down the entire assembly 100. Additionally, the balance between the motors 125, 175 is achieved in a manner that encourages the use of electric motors such as PMSM's which are particularly suited to handle substantially constant, though adjustable, speeds in conjunction with variable torque outputs. Furthermore, an electric motor such as a PMSM may be employed that operates at an efficiency substantially greater than 70%. Indeed, in one embodiment, the assembly 100 employs PMSM's that operate at efficiencies substantially greater than 90%.

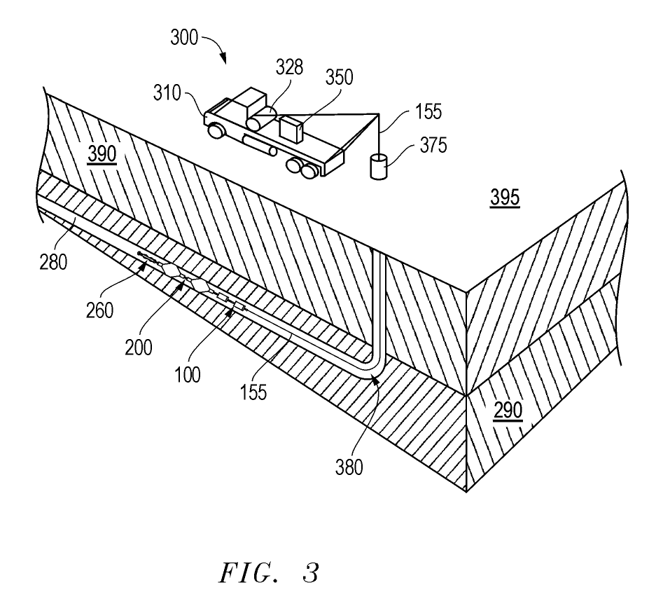

Continuing now with reference to FIG. 2, the downhole load sharing motor assembly 100 is depicted in a well 280 to provide driving power to a tractor 200 and diagnostic tool 260. With added reference to FIG. 3 and for sake of illustration, the assembly 100 is depicted as pulling the load of the tractor 200 and tool 260 to the right in an uphole direction similar to the arrow 190 of FIG. 1. In one embodiment, the assembly 100 is configured to supply between about 0 and about 15 kilowatts to ensure sufficient controlled power in pulling the load.

In the embodiment shown, the well 280 is defined by a borehole casing 285 running through a formation 290. The diameter (D) of the well 280 as defined by the casing 285 may be of conventional sizing, say between about 6 and about 18 inches across. Whereas a conventional single motor equipped to supply 0-15 kilowatts of power may exceed the diameter (D) of the well 280, the assembly 100 is made up of multiple motors 125, 175 having a width (w) that is significantly less than the noted diameter (D). For example, in one embodiment the width (w) may be less than about 6 inches. Thus, power requirements for driving the operation may be achieved with the downhole assembly 100 without concern over sizing constraints.

The embodiment shown includes two motors 125, 175 linked through a physical coupling 210, each for powering a sonde 220, 230 as described below. However, in other embodiments where more power is sought, additional motors and/or sondes may be similarly linked in a linear fashion and incorporated into the assembly 100. That is, a user-friendly manner of assembly construction may be provided wherein an operator is afforded a host of substantially interchangeable off-the-shelf modular motors. As such, the operator may choose the number of such motors for linking together in constructing the assembly 100 depending on operation specific load parameters.

In the embodiment of FIG. 2, the assembly 100 is shown delivered downhole by a conventional well access line 255 such as a wireline. However, the assembly 100 may also be deployed by other forms of line 255 such as coiled tubing. With added reference to FIG. 3, the load of the line 255 may be largely accommodated by a winch 328. However, depending on well depth and other factors, a portion of the line load may fall to the tractor 200, as powered by the assembly 100, for driving in an uphole direction.

As noted above, the tractor 200 itself contributes to the load that is shared by the assembly 100. As depicted, the tractor 200 is an active downhole mechanism that includes two reciprocating sondes 220, 230 linked by a mechanical coupling 235. Further adding to the load downhole of the assembly 100 is the diagnostic tool 260. The depicted tool 260 may be a logging tool including a variety of diagnostic implements for sampling conditions within the well 280. For example, an ejector implement 262 and a saturation implement 268 may be provided to obtain water flow information. Other diagnostic implements may include an imaging implement 266 as well as a fullbore spinner implement 264 to measure fluid velocity. Regardless, unlike the tractor 200, the diagnostic tool 260 is largely passive in that only minimal power is utilized in its operation. Nevertheless, the weight of the tool 260 may add significantly to the load that is imparted on the assembly 100 as the equipment is advanced in an uphole direction as described. Of course, it may be even more common that the tractor 200 is employed to pull the load in the downhole direction.

In powering the advance of the equipment uphole, the assembly 100 may employ a speed reduction technique. As described above with reference to FIG. 1, this technique may help to ensure that the load is substantially evenly distributed between the motors 125, 175. However, as also noted, this technique may be employed without reliance on high-speed communication between the motors 125, 175 themselves. So, for example, the coupling 210 or other structure between the motors 125, 175 need not accommodate a sophisticated bus or other features susceptible to overload during operation. Rather, each motor 125, 175 is equipped with its own independent processing component 225, 275 for load detection and speed adjustment as described above. For example, each component 225, 275 may include a microprocessor for monitoring torque output and adjusting motor speed in accordance with the speed reduction technique as described above. Thus, the motors 125, 175 are independently self-regulated so as to maintain a substantially balanced load share.

Referring now to FIG. 3, an overview of the larger environment of the well 280 at an oilfield 395 is depicted. Surface equipment 300 including a wireline truck 310 equipped with a winch 328 for delivering the well access line 155 to the well 280 is shown. A control unit 350 is positioned on the truck 310 for directing the deployment and retrieval of the line 155 from the well 280. The wireline truck 310 provides a mobile operationally friendly manner for conducting the operation. However, other forms of surface delivery and retrieval equipment may also be employed.

From the vantage point of FIG. 3, the horizontal or deviated nature of the region of the well 180 accommodating the load sharing motor assembly 100, tractor 200, and diagnostic tool 260 is apparent. Additionally, a relatively sharp bend 380 in the well 280 is visible. Uphole of the tortuous bend 380, a relatively vertical portion of the well 280 traverses another formation layer 390 ultimately leading out to the well head 375. These morphological features of the well 280 along with its depth, the amount of line 155 in the well, and other factors may all play a role in the amount of load to be accommodated by the assembly 100. For example, a certain amount of load may be accommodated by the assembly 100 with the downhole equipment positioned as depicted. However, as the assembly 100 is drawn uphole, the load may fluctuate, perhaps increasing a bit in deviated regions or as the assembly 100 and other downhole equipment round the depicted bend 380. Similarly the load may increase as the equipment makes it into the vertical portion of the well 280. Regardless, as noted above, and graphically detailed below, the load accommodated by the assembly 100 at any given point in time is substantially evenly distributed between the motors 125, 175 (see FIG. 2).

Referring now to FIGS. 4A-4C, with added reference to FIG. 2, charts are shown depicting the effects of an embodiment of a speed adjustment technique carried out by the above noted independent processing components 225, 275. Namely, the technique may be employed so as to avoid a circumstance in which the motors 125, 175 diverge from one another in terms of accommodating load as reflected by torque output (see FIG. 4A). Rather, by implementation of speed reduction based on torque output as indicated in FIG. 4B, substantially balanced load sharing between the motors 125, 175 may be achieved (see FIG. 4C).

With particular reference to FIG. 4A and added reference to FIG. 2, speeds 425, 475 of the different motors 125, 175 of the load sharing assembly 100 are tracked over a period of about 8 seconds. As indicated above, the motors 125, 175 may be of a PMSM or other substantially constant adjustable speed motor configuration. In examining the chart of FIG. 4A, the substantially constant speed configuration of the motors 125, 175 is apparent. That is, as the motors 125, 175 are started their speeds 425, 475 jump and level off to a relatively stable 50 rad/s after only about 1 second into operation.

As opposed to motor speed, the measure of load sharing between the motors 125, 175 may be seen with reference to the torque outputs 426, 476. In the chart of FIG. 4A, the first motor 125 operates at a substantially constant speed 425 but begins to take on more than its share of the load as time progresses, as evidenced by its torque output 426. Correspondingly, while second motor 175 maintains its substantially constant speed 475, it also begins to accommodate less and less of the load over time, as evidenced by its apparent decreasing torque output 476. As depicted in FIG. 4A, without correction, this natural phenomenon could continue until the second motor 175 does no more than actually add to the load that must be accommodated by the first motor 125. Of course, depending on the value of the torque outputs involved, the first motor 125 may be overloaded and fail well before the second motor 175 is able to add to the load accommodated by the first motor 125. However, as indicated above and described below, the assembly 100 is configured to operate in a manner that such unbalanced load sharing may be eliminated through use of a speed correction technique.

Referring now to FIG. 4B, a graphic depiction of speed reduction as initially indicated with reference to FIG. 1 and the equation ωm=ωref−kτ, is shown. Namely, in the chart of FIG. 4B, a speed reduction of kτ (as also indicated at 135, 185 of FIG. 1), is applied to each motor 125, 175. The amount of this reduction may be based on a predetermined constant (k) that is tied to the amount of torque (τ) displayed by each motor 125, 175. So, for example, at 420 of FIG. 4B, it is apparent that the predetermined constant (k) is about 20, as speed (RPM) is dropped by about 20 RPM for each Newton meter (Nm) of torque output. Applying this example to the assembly 100 of FIG. 2, this means that the processing components 225, 275 may be individually programmed to drop the speed of the motors 125, 175 by 20 RPM for every Nm of torque output by the respective motors 125, 175. Thus, when a divergence in torque output begins to occur as depicted in FIG. 4A, real-time correction may occur with the speed 425 of the overloaded motor 125 dropping. This results in the other motor 175 raising its torque output and substantially balancing the load sharing between the motors 125, 175.

A balance of load sharing between the motors 125, 175 through application of the above described speed reduction technique is depicted at FIG. 4C. As shown, the difference between the torque outputs 426, 476 of the motors 125, 175 over the course of their operation is relatively indistinguishable. Thus, a substantial balance 400 in the load is achieved as between the motors 125, 175. Indeed, only where the predetermined constant (k) is substantially 0 as shown at 401 of FIG. 4B, does the divergence of load share as indicated at FIG. 4A persist. Furthermore, as shown in FIG. 4C, the torque output is relatively stable for each motor 125, 175 over the period examined (at about 4.75 Nm). Thus, the motor speeds 425, 475 and hence, the speed of the assembly 100 remains relatively stable for this period as well.

Returning to reference to FIG. 4B, load balance may be substantially maintained over a relatively broad range of positive non-zero values for the predetermined constant (k). That is, as described above, the constant (k) may be 20. However, the constant may be much lower or higher, depending on the amount of precision sought in the balance of the load. For example, in order to increase the precision in load balance, the value of the constant (k) may be increased. This is shown in FIG. 4B where at 460, a value of about 60 is given for the constant (k). As such, a sharper reduction in speed results for each Nm of torque output. However, this also results in a quicker and more drastic return to load balance between motors 125, 175. In a practical sense, with reference to FIGS. 2 and 3, this means that a sharper reduction in the speed of the uphole advancement of the tractor 200 and assembly 100 may occur in locations where a greater load is seen. Thus, unlike the period examined in FIG. 4C, the tractor 200 may noticeably slow down as it advances uphole and around the bend 380, only to later speed up as it enters a vertical section of the well 180. Regardless, the uphole advancement will proceed with a highly precise balance of load between the motors 125, 175.

While it may be a matter of design choice as to how precise to make the balance of load share, even a small amount of speed reduction will ensure a substantially balanced load as between the motors 125, 175. For example, in an embodiment such as that of FIG. 4B where motor speed is at about 1,000 RPM and a constant (k) of about 20 employed, the degree of load imbalance between the motors 125, 175 will be no more than about 1% throughout a given operation such as that depicted in FIGS. 2 and 3.

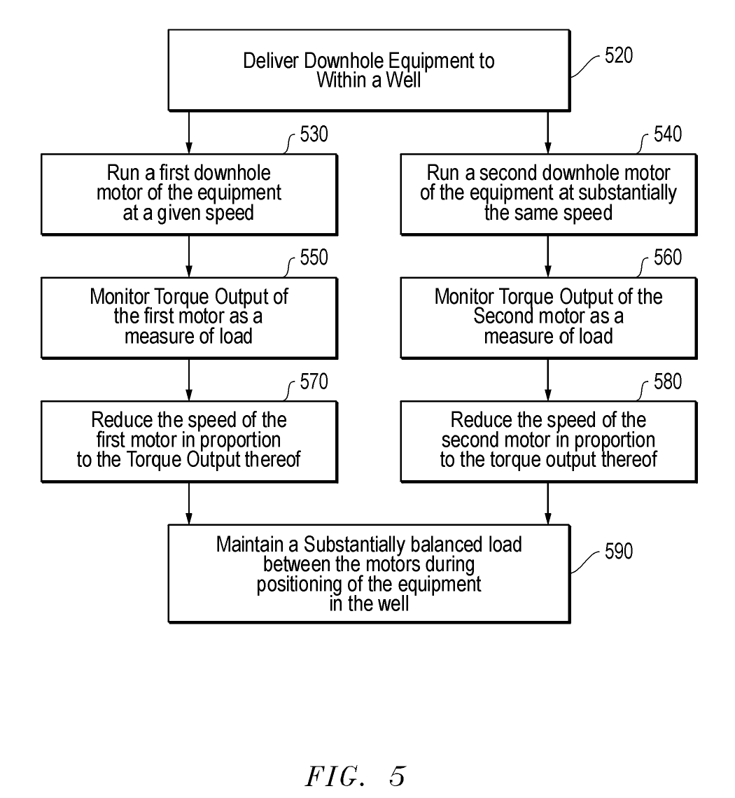

Referring now to FIG. 5, a flow-chart is provided summarizing the described speed reduction technique in conjunction with a downhole load sharing motor assembly. As indicated at 520, downhole equipment may be delivered to within a well. This equipment may include the downhole load sharing motor assembly along with a host of other equipment as detailed hereinabove. Indeed, the motor assembly may help to power the initial downhole positioning of the equipment, even employing the speed reduction technique described here. Regardless, the motor assembly may be utilized in conjunction with a speed reduction technique that includes running a first motor at a given speed and a second motor at substantially the same speed (530, 540). Torque outputs of the motors may then be monitored as indicated at 550 and 560 so as to provide a measure of load accommodated by each motor. Then, in order to balance the load, the speeds of the motors may be downwardly adjusted in direct proportion to the torque outputs of the respective motors (570, 580). In this manner, a substantial balance of load between the motors may be maintained as indicated at 590, even as the assembly continues to power the positioning of the equipment within the well.

Embodiments described hereinabove include load sharing multiple motor assemblies for which separate motors may be synchronized to behave in a manner ensuring a substantial balance of load between them. However, this synchronization is achieved in a manner which does not require sophisticated electronics or communications between the motors themselves. The results may also include more efficient utilization of all of the motors involved and a reduction in the likelihood that any of the motors will fail due to uneven fatigue or an exceeded torque output threshold. Additionally, the motors employed may be of a substantially constant adjustable speed variety which lend themselves to speed reduction techniques detailed herein and have efficiencies that substantially exceed 70%.

The preceding description has been presented with reference to presently preferred embodiments. Persons skilled in the art and technology to which these embodiments pertain will appreciate that alterations and changes in the described structures and methods of operation may be practiced without meaningfully departing from the principle, and scope of these embodiments. For example, embodiments described herein are directed primarily at dual motor assembly configurations employing permanent magnet synchronous machine motors. However, techniques described herein may be employed with alternative motor types and with more than two motors while still maintaining a substantial load sharing balance between all motors of the assembly. Furthermore, the foregoing description should not be read as pertaining only to the precise structures described and shown in the accompanying drawings, but rather should be read as consistent with and as support for the following claims, which are to have their fullest and fairest scope.

We claim:

1. A load sharing motor assembly for operating in a well and comprising:
a first motor coupled to downhole equipment and configured for operating at a given speed; and
a second motor coupled to the downhole equipment and configured for operating at substantially the given speed, the speed of each said motor to be reduced based on a corresponding torque output of each said motor.

2. The load sharing motor assembly of claim 1 wherein said second motor is coupled to the downhole equipment via said first motor.

3. The load sharing motor assembly of claim 1 wherein the downhole equipment includes one of a downhole tractor and a diagnostic tool.

4. The load sharing motor assembly of claim 1 wherein said first motor comprises a processing component for monitoring the torque output thereof and directing the speed reduction thereto.

5. The load sharing motor assembly of claim 1 wherein said first motor is of an efficiency greater than about 70%.

6. The load sharing motor assembly of claim 1 configured for accommodating a substantially balanced load between said motors, the load provided by one of the downhole equipment, the load sharing motor assembly and a well access line coupled thereto.

7. The load sharing motor assembly of claim 6 wherein said accommodating is achieved without communication of torque output information between said motors.

8. A method of maintaining a substantially balanced load in a downhole motor assembly, the method comprising:
running first and second motors of the assembly;
monitoring torque output of the motors; and
adjusting speeds of the motors based on the torque output.

9. The method of claim 8 wherein the substantially balanced load includes a load imbalance between the motors of less than about 1%.

10. The method of claim 8 wherein said adjusting comprises reducing the speed of each motor independently based on a predetermined constant applied to the torque output of each motor respectively.

11. The method of claim 10 wherein the predetermined constant is a positive non-zero number.

12. A method of performing an application in a well, the method comprising:
positioning a well access line in a well with a motor assembly coupled thereto;
operating first and second motors of the assembly at substantially the same speed;
accommodating a load in the well with torque outputs from the motors;
reducing the individual speed of each motor in accordance with the amount of its torque output, said reducing for maintaining a substantial balance of the load between the motors during the performing.

13. The method of claim 12 wherein said accommodating of the load comprises accommodating one of downhole equipment, the assembly, and the well access line.

14. The method of claim 13 wherein the downhole equipment comprises a tractor, said accommodating further comprising powering the tractor for moving the assembly and well access line in the well.

15. The method of claim 14 wherein the moving comprises traversing a load increasing region of the well.

16. The method of claim 15 wherein the load increasing region includes one of a deviated well region and a tortuous well region.

17. The method of claim 15 wherein the moving slows within the well during the traversing without sacrifice to the maintaining.

18. A downhole assembly for operating in a well and comprising:
a first substantially constant adjustable speed motor; and
a second substantially constant adjustable speed motor coupled to said first substantially constant adjustable speed motor, said motors configured to each accommodate a substantially equivalent share of a load in the well.

19. The downhole assembly of claim 18 wherein said first substantially constant adjustable speed motor is a permanent magnet synchronous machine motor.

20. The downhole assembly of claim 18 wherein said first and second motors are of substantially interchangeable modular configuration.

21. The downhole assembly of claim 18 further comprising a third substantially constant adjustable speed motor coupled to one of said first and second motors.

22. The downhole assembly of claim 18 configured to supply up to about 15 kilowatts for the operating.

23. The downhole assembly of claim 18 wherein the well is of a given diameter, each said motor of a width significantly smaller than the diameter.
